(19) United States
(12) Patent Application Publication
(10) Pub. No.: US 2025/0047761 A1
(43) Pub. Date: Feb. 6, 2025

(54) SCHEDULING OF MACHINE LEARNING RELATED DATA

(71) Applicant: Nokia Technologies Oy, Espoo (FI)

(72) Inventors: Diomidis MICHALOPOULOS, Munich (DE); Taylan SAHIN, Munich (DE); Prajwal KESHAVAMURTHY, Munich (DE)

(21) Appl. No.: 18/788,693

(22) Filed: Jul. 30, 2024

Related U.S. Application Data
(60) Provisional application No. 63/517,359, filed on Aug. 3, 2023.

(51) Int. Cl. H04L 67/61; H04L 41/16; H04W 72/21; H04W 72/23; H04W 72/40

(52) U.S. Cl. CPC H04L 67/61; H04L 41/16; H04W 72/21; H04W 72/23; H04W 72/40

(57) ABSTRACT

A method comprising: receiving, at a first apparatus from a second apparatus, characteristic information of data to be transmitted to or from the second apparatus, wherein the data is related to a machine learning model; and determining assistance information for scheduling a transmission of the data at least based on the characteristic information.

### FIELDS

Various example embodiments of the present disclosure generally relate to the field of telecommunication and in particular, to methods, apparatuses and computer readable storage medium for scheduling of machine learning (ML)-related data.

### BACKGROUND

Several technologies have been proposed to improve communication performances. For example, communication devices may employ an artificial intelligence (AI)/ML model to improve communication qualities. The AI/ML model can be applied to different scenarios to achieve better performances. To this end, transfer of AI/ML related data between different entities is needed enable use of the AI/ML model.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, characteristic information of data to be transmitted to or from the second apparatus, wherein the data is related to a machine learning model; and determine assistance information for scheduling a transmission of the data at least based on the characteristic information.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, characteristic information of data to be transmitted to or from the second apparatus, wherein the data is related to a machine learning model, and wherein the characteristic information is used for determining assistance information for scheduling a transmission of the data.

In a third aspect of the present disclosure, there is provided a third apparatus. The third apparatus comprises at least one processor; and at least one memory storing instructions that, when executed by the at least one processor, cause the third apparatus at least to: receive, from a first apparatus, assistance information for scheduling a transmission of data to be transmitted to or from a second apparatus, wherein the data is related to a machine learning model; determine, based on the assistance information, scheduling information used for or to be used for the transmission of the data; and transmit the scheduling information to the first apparatus.

In a fourth aspect of the present disclosure, there is provided a method. The method comprises: receiving, at a first apparatus from a second apparatus, characteristic information of data to be transmitted to or from the second apparatus, wherein the data is related to a machine learning model; and determining assistance information for scheduling a transmission of the data at least based on the characteristic information.

In a fifth aspect of the present disclosure, there is provided a method. The method comprises: transmitting, to a first apparatus from a second apparatus, characteristic information of data to be transmitted to or from the second apparatus, wherein the data is related to a machine learning model, and wherein the characteristic information is used for determining assistance information for scheduling a transmission of the data.

In a sixth aspect of the present disclosure, there is provided a method. The method comprises: receiving, from a first apparatus at a third apparatus, assistance information for scheduling a transmission of data to be transmitted to or from a second apparatus, wherein the data is related to a machine learning model; determining, based on the assistance information, scheduling information used for or to be used for the transmission of the data; and transmitting the scheduling information to the first apparatus.

In a seventh aspect of the present disclosure, there is provided a first apparatus. The first apparatus comprises means for receiving, from a second apparatus, characteristic information of data to be transmitted to or from the second apparatus, wherein the data is related to a machine learning model; and means for determining assistance information for scheduling a transmission of the data at least based on the characteristic information.

In an eighth aspect of the present disclosure, there is provided a second apparatus. The second apparatus comprises means for transmitting, to a first apparatus, characteristic information of data to be transmitted to or from the second apparatus, wherein the data is related to a machine learning model, and wherein the characteristic information is used for determining assistance information for scheduling a transmission of the data.

In a ninth aspect of the present disclosure, there is provided a third apparatus. The third apparatus comprises means for receiving, from a first apparatus, assistance information for scheduling a transmission of data to be transmitted to or from a second apparatus, wherein the data is related to a machine learning model; means for determining, based on the assistance information, scheduling information used for or to be used for the transmission of the data; and means for transmitting the scheduling information to the first apparatus.

In a tenth aspect of the present disclosure, there is provided a computer readable medium. The computer readable medium comprises instructions stored thereon for causing an apparatus to perform at least the method according to the fourth aspect.

In an eleventh aspect of the present disclosure, there is provided a computer readable medium. The computer readable medium comprises instructions stored thereon for causing an apparatus to perform at least the method according to the fifth aspect.

In a twelfth aspect of the present disclosure, there is provided a computer readable medium. The computer readable medium comprises instructions stored thereon for causing an apparatus to perform at least the method according to the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example communication environment in which example embodiments of the present disclosure can be implemented;

FIG. 1B illustrates another example communication environment in which example embodiments of the present disclosure can be implemented;

FIG. 1C illustrates a further example communication environment in which example embodiments of the present disclosure can be implemented;

FIG. 2 illustrates an example signaling flow of scheduling ML related data according to some example embodiments of the present disclosure;

FIG. 3 illustrates an example signaling flow of scheduling ML related data according to some example embodiments of the present disclosure;

FIG. 4 illustrates a flowchart of a method implemented at a first apparatus according to some example embodiments of the present disclosure;

FIG. 5 illustrates a flowchart of a method implemented at a second device according to some example embodiments of the present disclosure;

FIG. 6 illustrates a flowchart of a method implemented at a third device according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “AI/ML model” may refer to a data driven algorithm that applies AI/ML techniques to generate a set of outputs based on a set of inputs. In the context of the present disclosure, the term “AI/ML model” may be used interchangeably with the terms “model”, “AI model” and “ML model”. The term “AI/ML” may be used interchangeably with the terms “AI” and “ML”.

As used herein, the term “data collection” may refer to a process of collecting data by the network nodes, a management entity, or UE for any suitable purpose. The purpose may include but not limited to training, data analytics and inference, monitoring (for example, performance monitoring), retraining, updating and tuning of the AI/ML model/functionality/feature.

As used herein, the term “data related to a ML model” or “ML-related data” may refer to data for any suitable purpose of the ML model or for any suitable stage associated with the ML model. For example, the ML-related data may include data for one or more of ML model training, monitoring, retraining, analytics and inference, etc. In the following, the terms “data related to a ML model” and “ML-related data” may be used interchangeably.

The term “UE-side (AI/ML) model” used herein may refer to an AI/ML Model of which inference is performed entirely at the UE. The term “network-side (AI/ML) model” used herein may refer to an AI/ML Model of which inference is performed entirely at the network. The term “one-sided (AI/ML) model” used herein may refer to a UE-side (AI/ML) model or a network-side (AI/ML) model. The term “two-sided (AI/ML) model” used herein may refer to a paired AI/ML Model(s) over which joint inference is performed, where joint inference comprises AI/ML Inference whose inference is performed jointly across the UE and the network, i.e, the first part of inference is firstly performed by UE and then the remaining part is performed by gNB, or vice versa.

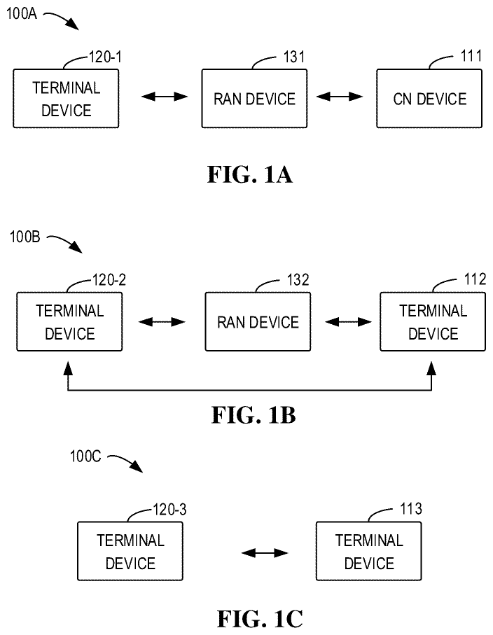

FIG. 1A, FIG. 1B and FIG. 1C illustrate example communication environments 100A, 110B and 100C in which example embodiments of the present disclosure can be implemented. In any of the communication environments 100A, 100B and 100C, machine learning (for example, one or more ML models) may be used for a functionality, including but not limited to, positioning, beam management, and channel state information (CSI) feedback. Such a functionality may be also referred to as AI/ML related functionality or ML-related functionality.

Specifically, the environment 100A includes a terminal device 120-1, a radio access network (RAN) device 131 and a core network (CN) device 111. The terminal device 110-2 may be any suitable type of terminal device, for example, a UE or a positioning reference unit (PRU). The RAN device 131 may be any suitable RAN node, for example, a gNB. The CN device 111 may comprise one or more network functions (NFs). The specific NFs may depend on the AI/ML functionality. For example, in the case of AI/ML for positioning, the CN device 111 may include a Location Management Function (LMF) and/or a Network Data Analytics Function (NWDAF). Alternatively, the LMF and/or the NWDAF may be implemented at an RAN device, which may be different from or the same as the RAN device 131.

The LMF can request capabilities of UE related to positioning, provide assistance data (e.g., reference nodes and configuration of positioning signal) to UE, and obtain location information (location measurement data and/or location estimate from a target UE). The LMF may use the LTE Positioning Protocol (LPP) to communicate with a target device (that is the UE), and use New Radio Positioning Protocol A (NRPPa) protocol to communicate with a gNB.

LMF may decide on the positioning method (for example, based on QoS, UE/gNB capabilities), and invokes it at UE/gNB, either via UE-based positioning in which UE calculates the location estimate or UE-assisted/NW-based positioning in which UE provides measurements, and LMF calculates the location estimate. LMF may combine all results and determine single location estimate as well as the accuracy of the estimate and velocity.

PRUs are UEs with known location, supporting UL/DL positioning measurements, which can be collected by LMF and compared with known PRU location to determine correction terms for other nearby UEs.

The NWDAF may collect location information for a target UE or a group of target UEs from LCS system. The collected location related information may include but not limited to location estimate of the UE; time stamp of location estimate; velocity of the UE; information about the positioning method used to obtain the location estimate of the UE; an indication of area event, when UE enters, is within or leaves the geographical area;
an indication of motion event when UE moves by more than some predefined straight line distance from a previous location.

NWDAF may check user consent taking the purpose for data collection and usage of these data into account. NWDAF checks the user consent by retrieving the user consent information from UDM.

The user consent is subscription information stored in the Unified Data Management (UDM) function, which may include whether the user authorizes the collection and usage of its data for a particular purpose; and the purpose for data collection, e.g. analytics or model training.

The environment 100B includes a terminal device 120-2, an RAN device 132 and a terminal device 112. In this example, the terminal device 120-2 may perform sidelink (SL) communication and operate in SL resource allocation mode 1, which is also referred to as a network scheduled resource allocation scheme. In SL resource allocation mode 1, the resource for the sidelink communication by the terminal device 120-2 may be scheduled by the RAN device 132. The RAN device 132 may be any suitable RAN node, for example, a gNB. The terminal device 112 is different from the terminal device 120-2. For example, the terminal device 112 may be a terminal device in SL communication with the terminal device 120-2, or a server terminal device, such as a server UE.

The environment 100C includes a terminal device 120-3, and a terminal device 113. In this example, the terminal device 120-3 may perform SL communication and operate in SL resource allocation mode 2, which may be also referred to as an autonomously resource selection scheme. In SL resource allocation mode 2, the resource for the sidelink communication is selected by the terminal device 120-3. In other words, the terminal device 120-3 in SL resource allocation mode 2 may schedule SL transmission on its own without being scheduled by the network. Similar to FIG. 1B, the terminal device 113 may be a terminal device in SL communication with the terminal device 120-3, or a server terminal device, such as a server UE.

Communications in the communication environments 100A, 100B and 100C may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In the following, the terminal devices 120-1, 120-2 and 120-3 may be referred to as terminal devices 120 collectively or as terminal device 120 individually. As mentioned above, in any of the communication environments 100A, 100B and 100C, ML related functionality may be used. To enable the ML related functionality, data collection is needed. For example, the terminal device 120 may have ML-related data to be transmitted to another entity or another entity may have ML-related data to be transmitted to the terminal device 120. Now taking the AI/ML for positioning as an example to illustrate some examples regarding data collection.

Use cases for positioning may include one-step approach (which is also referred to as direct AI/ML positioning) and two-step approach (which is also referred to as AI/ML assisted positioning). In the one-step approach, the AI/ML model outputs the UE location, e.g., fingerprinting based on channel observation as the input of AI/ML model. In the two-step approach, the AI/ML model outputs new measurement and/or enhancement of existing measurement, e.g., Line-of-Sight (LOS)/Non-Line-of-Sight (NLOS) identification, timing and/or angle of measurement, likelihood of measurement.

More specifically, the following cases may be possible:
Case 1: UE-based positioning with UE-side model, direct AI/ML or AI/ML assisted positioning;
Case 2a: UE-assisted/LMF-based positioning with UE-side model, AI/ML assisted positioning;
Case 2b: UE-assisted/LMF-based positioning with LMF-side model, direct AI/ML positioning;
Case 3a: next generation (NG)-RAN node assisted positioning with gNB-side model, AI/ML assisted positioning;
Case 3b: NG-RAN node assisted positioning with LMF-side model, direct AI/ML positioning.

One-sided model whose inference is performed entirely at the UE or at the network may be prioritized.

Some aspects of signaling, report and feedback with regards to data collection for ML-based positioning are now given as examples. An aspect may include details of request/report of label and/or other training data, and to enable delivering the collected label and/or other training data to the training entity when the training entity is not the same entity to obtain label and/or other training data.

Another aspect may include assistance signaling indicating reference signal configuration(s) to derive label and/or other training data.

A further aspect may include request/report of training data, for example but not limited to: ground truth label; measurement corresponding to model input; associated information of ground truth label and/or measurement corresponding to model input.

A yet further aspect may include assistance signaling and procedure to facilitate generating training data, for example but not limited to: reference signal (e.g., positioning reference signal (PRS)/sounding reference signal (SRS)) configuration(s) and configuration identifier; assistance information, e.g., between LMF and UE/PRU, for label calculation/generation, and label validity/quality condition, etc.

It is to be noted that whether such assistance signaling and procedure can be applied to other aspect(s) of AI/ML model life cycle management (LCM) is to be specified. It is also to be noted that different entity to generate training data as well as different types of training data when applicable may be considered, and that both of the following cases when applicable may be considered: when the training entity is the same entity to generate training data, and when the training entity is not the same entity to generate training data.

Some aspects of training data collection for AI/ML based positioning are now given as examples. Associated information of training data may include but not limited to ground truth label at least for model training; report from the label data generation entity; measurement (corresponding to model input) at least for model training; report from the measurement data generation entity; quality indicator for and/or associated with ground truth label and/or measurement at least for model training; report from the label and/or the measurement data generation entity and/or as request from a different (e.g., data collection, etc.) entity; RS configuration(s) at least for deriving measurement; time stamp at least for and/or associated with training data for model training; report from data generation entity together with training data and/or as LMF assistance signaling. RS configuration may involve request from data generation entity (for example, UE/PRU/transmission and reception point (TRP)) to LMF and/or as LMF assistance signaling to UE/PRU/TRP. Time stamp may include a separate time stamp for measurement and ground truth label, when the measurement and ground truth label are generated by different entities.

Assistance signaling and procedure to facilitate generating/collecting training data may include but not limited to potential determination of the UE/PRU/TRP which can provide the training data; configuration of reference signal (for measurement and/or label); signaling other than above two items for data collection, e.g., requested quality of training data.

In addition to training, data collection aspects have been also identified for model monitoring purposes. These data collection aspects may include but not limited: if certain type of data is necessary for computing monitoring metric, how an entity can be used to provide the given type of data for calculating monitoring metric; potential signaling for provisioning of the given type of data for calculating associated monitoring metric; and potential assistance signaling and procedure to facilitate an entity providing data for calculating monitoring metric.

Regarding data collection, some solutions may focus on data collection solutions for both NW- and UE-sided AI/ML models, including assistance signalling and (dataset) reporting from the concerning entity. Implications of data collection for all concerning LCM purpose, e.g., model training/monitoring/selection/update/inference/etc., may be studied. In some solutions, the data collection requirements and solutions for the different LCM purposes may be analyzed separately. In some solutions, the following metrics may be considered as a starting point: a) the content of the data, b) the data size, c) latency and periodicity, d) signalling, entities involved, and configuration aspects.

Several example aspects regarding data collection for AL/ML models are described. In general, the ML-based methods for positioning require large amounts of data, mainly for training, monitoring, and retraining the ML model. The data includes positioning-related measurements, e.g., time/angle/phase/power-based measurements conducted by UE using DL PRS or by gNB using UL SRS, Channel Impulse Response (CIR), packet data protocol (PDP), that are typically input to the model, as well as any ground truth information associated with them (such as UE location information, LOS/NLOS channel type indication, etc.) which are used as “labels” for training supervised ML models.

The volume of data that needs to be transferred for ML-related purposes may be in fact even larger if besides positioning, other ML-based approaches such as beam management and channel state information feedback are considered. In other words, large amount of data is expected to be transferred between UE and network entities in the upcoming releases to address the multiple ML-assisted use cases. In the following, some example embodiments are described with respect to the use case of the positioning as examples.

According to some mechanisms, users' data to be transmitted between entities may be prioritized on the basis of data-plane quality of service (QoS) priorities without any consideration on the ML-related data transfer. That is, the decision on which user's data packets are transmitted first does not take into account potential data for ML purposes, which, as described above, may take up large data volumes on the order of application-layer data.

In these mechanisms, ML-related priorities are ignored in data transmission scheduling. The impact of such ignorance of ML-related priorities in scheduling a data transmission is that ML-based solutions for the air interface, such as positioning as an example, cannot work properly. Therefore, efficient mechanisms are necessary that include data for ML-based air interface use cases into QoS prioritization and/or scheduling of data transfer procedures.

According to some example embodiments of the present disclosure, there is provided a solution for scheduling ML-related data. In the solution, a first entity may receive, from a second entity, characteristic information of ML-related data to be transmitted to or from the second entity. Based on the received characteristic information, the first entity may determine assistance information for scheduling a transmission of the ML-related data. Then, the assistance information may be used by an entity, which schedules data transmission for the second entity, to determine scheduling information for the transmission of the ML-related data. The ML-related data may be transmitted according to the scheduling information. Alternatively, the ML related functionality may be updated to according to the scheduling information.

In the proposed solution, characteristics of the ML-related data are considered for scheduling transmission of the ML-related data. In this way, the ML-related functionality, for example positioning, beam management and CSI feedback, can work properly, thus improving communication performance.

Example embodiments of the present disclosure will be described in detail below with reference to the accompanying drawings.

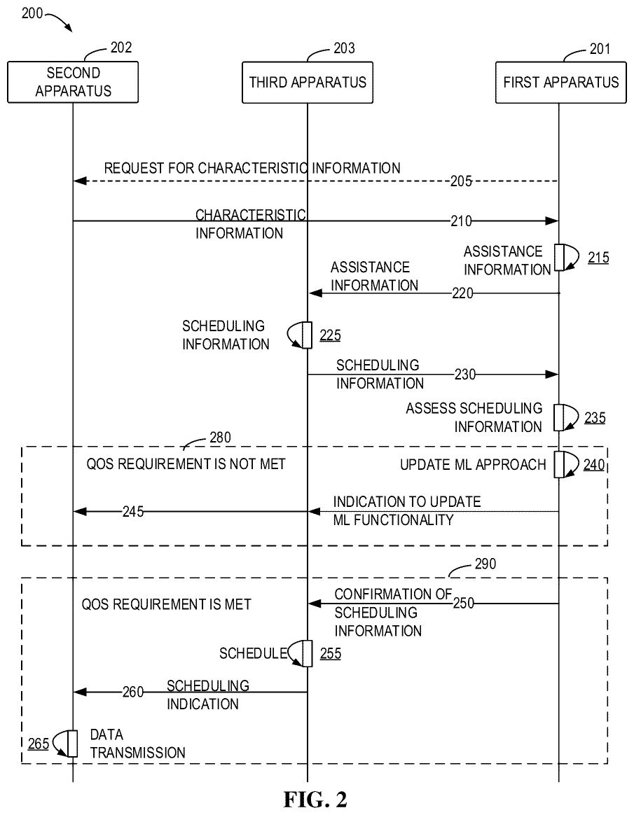

FIG. 2 illustrates an example signaling flow 200 of scheduling ML related data according to some example embodiments of the present disclosure. The signaling flow 200 may involves the first apparatus 201, the second apparatus 202 and the third apparatus 203. An ML model may be included or implemented in any one or more of the first apparatus 201, the second apparatus 202 and the third apparatus 203. For example, the ML model may be run or carried out at the one or more of the first apparatus 201, the second apparatus 202 and the third apparatus 203 for any suitable purpose for example training, retraining, updating, inference, monitoring. Data transfer for the ML model is needed. For example, data related to the ML model, which is also referred to as ML-related data, is to be transmitted to or from the second apparatus 202.

The ML-related data may be used for any suitable purpose, for example, training monitoring, retraining of the ML model. The functionality or use case of the ML model may include positioning, CSI feedback and beam management, for example. Other functionalities or use cases may be also possible.

In the flow 200, the third apparatus 203 may schedule data transmission for the second apparatus 202. In some example embodiments, the flow 200 may be implemented in the environment 100A. Accordingly, the first apparatus 201 may be implemented as or at the CN device 111, the second apparatus 202 may be implemented as or at the terminal device 120-1 and the third apparatus 203 may be implemented as or at the RAN device 131. For example, in the case of ML-related positioning, the first apparatus 201 may be implemented as or at the LMF or NWDAF, the second apparatus 202 may be implemented as or at the UE or PRU and the third apparatus 203 may be implemented as or at the gNB.

In some example embodiments, the flow 200 may be implemented in the environment 100B. In such example embodiments, transmission of the ML-related data may be SL transmission. Accordingly, the first apparatus 201 may be implemented as or at the terminal device 112, the second apparatus 202 may be implemented as or at the terminal device 120-2 and the third apparatus 203 may be implemented as or at the RAN device 132. For example, the first apparatus 201 may be implemented as or at the server UE, the second apparatus 202 may be implemented as or at the UE operating in SL resource allocation mode 1 and the third apparatus 203 may be implemented as or at the gNB serving the UE.

As shown in FIG. 2, the second apparatus 202 may transmit (210) characteristic information of the ML-related data to the first apparatus 201. For example, in the case of positioning, the UE having an ML-assisted positioning session with the LMF may provide the characteristics of the ML-related data to the LMF.

The characteristic information may include or indicate any suitable characteristics of the ML-related data. For example, the characteristic information may indicate the amount of the ML-related data. For another example, the characteristic information may include the data type of the ML-related data, for example, if the data is to be used for one step or two step positioning in the case of the positioning use case.

In some example embodiments, the characteristic information may relate to one or more of locations, timestamps, configurations associated with the ML-related data or measurement for obtaining the ML-related data. The configurations may include TRPs/anchors, PRS resource, bandwidth (BW), comb-size, etc. Alternatively, or in addition, the characteristic information may relate to statistics of the ML-related data, for example, the minimum value, the maximum value, the value range, a mean value, a variance of values, etc.

In some example embodiments, as shown in FIG. 2, the first apparatus 201 may transmit (205) a request for the characteristic information to the second apparatus 202. For example, the request may be included in a LPP message. Then, in response to the request, the second apparatus 202 may transmit (210) the requested characteristic information to the first apparatus 201.

Continuing with the flow 200, the first apparatus 201 may receive the characteristic information from the second apparatus 202 and may determine (215) assistance information for scheduling a transmission of the ML-related data at least based on the characteristic information. In some example embodiments, the assistance information may be determined further based on QoS information for the ML-related functionality, for example QoS requirement. For example, in the case of ML-related positioning, the assistance information may be determined further based on positioning QoS such as positioning accuracy and positioning latency.

The assistance information may include a priority of the ML-related data, which is also referred to as “data priority”. Alternatively, or in addition, the assistance information may further include or indicate one or more scheduling requirements for transferring the ML-related data. Example scheduling requirements may include but not limited to QoS boundaries, ranges, e.g., maximum/minimum/range of throughput, data volume, payload, latency, modulation and coding scheme (MCS), etc.

The first apparatus 201 may transmit (220) the assistance information to the third apparatus 203. For example, in the case of ML-related positioning, the CN device 111 may instigate a new Information Element (IE) as part of the positioning RAN procedures to indicate to the serving RAN device 131 (for example, the serving gNB) of the terminal device 110-1 the data priority of the ML-related data.

The third apparatus 203 may receive the assistance information from the first apparatus 201 and determine (225) scheduling information for the transmission of the ML-related data based on the assistance information. The scheduling information may include a scheduling priority of the transmission of the ML-related data. Alternatively, or in addition, the scheduling information may include one or more parameters related to QoS achieved or achievable to transfer the ML-related data. The parameters related to QoS may include for example but not limited to throughput, latency, etc. and also those described with respect to the assistance information.

In some example embodiments, the third apparatus 203 may determine the scheduling information based on the assistance information and a user plane condition of the second apparatus 202. For example, the scheduling priority derived by the third apparatus 203 may be a function as the data priority provided in the assistance information in conjunction with the data plane functions of the second apparatus 202.

The third apparatus 203 may transmit (230) the scheduling information to the first apparatus 201. In some example embodiments, the third apparatus 203 may schedule the transmission of the ML-related data based on the scheduling information. In such example embodiments, the scheduling information received at the first apparatus 201 has been used for the transmission of the ML-related data. Therefore, the scheduling information indicates the actual or achieved scheduling of the ML-related data. In other words, the third apparatus 203 may perform the actual scheduling and inform the first apparatus 201 of the scheduling information used in the actual scheduling.

Alternatively, in some example embodiments, the third apparatus 203 may transmit the scheduling information to the first apparatus 201 before performing actual scheduling. In such example embodiments, the scheduling information received at the first apparatus 201 is to be used for transmission of the ML-related data. The scheduling information indicates the achievable scheduling of the ML-related data.

The first apparatus 201 may receive, from the third apparatus 203, the scheduling information used for or to be used for transmission of the ML-related data. Then, the first apparatus 201 may assess (235) or evaluate the scheduling information with respect to the QoS requirement for the ML-related functionality. In other words, the first apparatus 201 may determine whether the scheduling information meets the QoS requirement for the ML-related functionality. In the case of ML-related positioning, the scheduling information may be evaluated with respect to the positioning QoS. For example, according to the QoS, a maximum latency for data transfer may be AA ms, while the scheduling information indicates a latency of BB ms for transferring the ML-related data. If BB is does not exceed AA, the QoS requirement is met. If BB exceeds AA, the QoS requirement may not be met.

If the first apparatus 201 determines that the QoS requirement is not met, the procedure 280 may be performed. Specifically, the first apparatus 201 may determine (240) to update the ML-related functionality. In other words, the first apparatus 201 may adapt the ML approach for the functionality in consideration (for example, the positioning, CSI feedback, or beam management). The updated approach may require smaller amount of data or may be more robust to the ML-related data to be transferred. It is to be understood that in the case that the scheduling information received from the third apparatus 203 has been used for scheduling, if the QoS requirement is not met, the ML-related functionality can also be updated, which means that the procedure 280 can be performed.

The update to the ML-related functionality may include a switch from the ML model to another ML model designed for the functionality, such as a switch from a first ML model used in a one-step approach to a second ML model used in a two-step approach. Alternatively, or in addition, the update may include a fallback from the ML-based approach to a conventional approach. Other types of updates may be possible.

As an example without any limitation, in the case of ML-related positioning, the LMF may use or select a lower-rank positioning approach that requires smaller volume of data or that is more robust to the ML-related data provided by the UE. For example, a two-step method that uses the ML model only for an intermediate parameter of the final location estimate may be selected rather than a one-step method, e.g., fingerprinting, that depends exclusively on the ML-related data to derive the location estimate.

Next, the first apparatus 201 may transmit (245), to the second apparatus 202 and/or the third apparatus 203, an indication to update the ML-related functionality. In the environment 100A, the indication may be transmitted from the CN device 111 to the terminal device 110-2 via LPP, and to the RAN device 131 via NRPPa. In the environment 100B, the indication may be transmitted from the terminal device 112 to the terminal device 120-1 via sidelink signaling, and to the RAN device 132 via any suitable uplink signaling.

Accordingly, the second apparatus 202 and the third apparatus 203 may receive the indication to update the ML-related functionality from the first apparatus 201. Then, the second apparatus 202 and the third apparatus 203 may update the ML-related functionality accordingly.

Reference is now made back to the act 235. If the first apparatus 201 determines that the QoS requirement is met, the procedure 290 may be performed. Specifically, the first apparatus 201 may transmit a confirmation of the scheduling information to the third apparatus 203. Accordingly, the third apparatus 203 may receive the confirmation from the first apparatus 201. If the scheduling information transmitted at 230 has been used for scheduling, the third apparatus 203 may continue to use the scheduling information for subsequent transmission of the ML-related data. If the scheduling transmitted at 230 is to be used for scheduling, the third apparatus 203 may schedule (255) the transmission of the ML-related data. The second apparatus 202 may receive (260) scheduling indication from the third apparatus 203 and perform (265) data transmission based on the scheduling indication.

For example, in the environment 100A, the RAN device 131 (such as gNB) may schedule the terminal device 120-1 for UL/DL transfer according to the scheduling information. The data transmission may also involve the CN device 111 (e.g., LMF in addition to gNB) as source, destination or hop. For another example, in the environment 100B, the RAN device 132 (such as gNB) may schedule the terminal device 120-2 for SL transfer according to the scheduling information. The data transmission may be performed between the terminal device 120-2 and the terminal device 112, and/or between the terminal device 120-2 and a further terminal device (not shown).

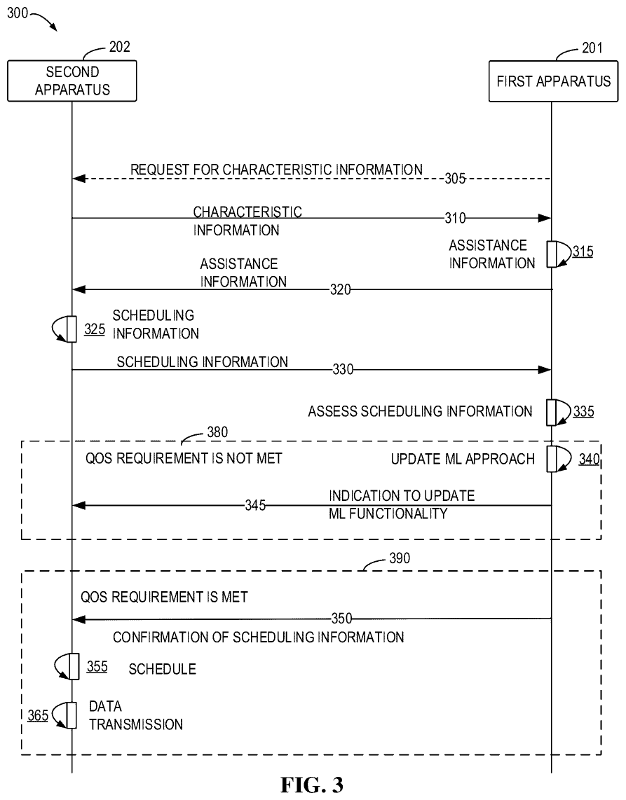

FIG. 3 illustrates another example signaling flow 300 of scheduling ML related data according to some example embodiments of the present disclosure. The signaling flow 300 may involve the first apparatus 201, and the second apparatus 202. An ML model may be included in any one or more of the first apparatus 201, and the second apparatus 202, and another apparatus (not shown). Data transfer for the ML model is needed. For example, data related to the ML model, which is also referred to as ML-related data, is to be transmitted to or from the second apparatus 202. The ML-related data may be similar as that described above with reference to FIG. 2 and thus description thereof is not repeated here.

In the flow 300, the second apparatus 202 may schedule data transmission on its own. For example, the second apparatus 202 may include a UE in SL resource allocation mode 2. In some example embodiments, the flow 300 may be implemented in the environment 100C. Accordingly, the first apparatus 201 may be implemented as or at the terminal device 113, and the second apparatus 202 may be implemented as or at the terminal device 120-3. For example, in the case of ML-related positioning, the first apparatus 201 may be implemented as or at the server UE, the second apparatus 202 may be implemented as or at the UE or PRU.

As shown in FIG. 3, the second apparatus 202 may transmit (310) characteristic information of the ML-related data to the first apparatus 201. For example, in the case of positioning, the UE having an ML-assisted positioning session with its server UE may provide the characteristics of the ML-related data to the server UE. The characteristic information may be similar as that described above with reference to FIG. 2 and thus description thereof is not repeated here.

In some example embodiments, as shown in FIG. 3, the first apparatus 201 may transmit (305) a request for the characteristic information to the second apparatus 202. Then, in response to the request, the second apparatus 202 may transmit (310) the requested characteristic information to the first apparatus 201.

Continuing with the flow 300, the first apparatus 201 may receive the characteristic information from the second apparatus 202 and may determine (215) assistance information for scheduling a transmission of the ML-related data at least based on the characteristic information. In some example embodiments, the assistance information may be determined further based on QoS information for the ML-related functionality, for example QoS requirement. For example, in the case of ML-related positioning, the assistance information may be determined further based on positioning QoS such as positioning accuracy and positioning latency.

The assistance information may include a priority of the ML-related data, which is also referred to throughout this document as “data priority”. Alternatively, or in addition, the assistance information may further include or indicate one or more scheduling requirements for transferring the ML-related data. Example scheduling requirements may include but not limited to QoS boundaries, ranges, e.g., maximum/minimum/range of throughput, data volume, payload, latency, modulation and coding scheme (MCS), etc.

The first apparatus 201 may transmit (320) the assistance information to the second apparatus 202. Accordingly, the second apparatus 202 may receive the assistance information from the first apparatus 201 and determine (325) scheduling information for the transmission of the ML-related data based on the assistance information. The scheduling information may include a scheduling priority of the transmission of the ML-related data. Alternatively, or in addition, the scheduling information may include one or more parameters related to QoS achieved or achievable to transfer the ML-related data. The parameters related to QoS may include for example but not limited to throughput, latency, etc. and also those described with respect to the assistance information.

In some example embodiments, the second apparatus 202 may determine the scheduling information based on the assistance information and a user plane condition of the second apparatus 202. For example, the scheduling priority derived by the second apparatus 202 may be a function as the data priority provided in the assistance information in conjunction with the data plane functions of the second apparatus 202.

The second apparatus 202 may transmit (330) the scheduling information to the first apparatus 201. In some example embodiments, the third apparatus 203 may schedule the transmission of the ML-related data based on the scheduling information. Transmission of the ML-related data may be performed based on the scheduling information. In such example embodiments, the scheduling information received at the first apparatus 201 has been used for the transmission of the ML-related data. Therefore, the scheduling information indicates the actual or achieved scheduling of the ML-related data. In other words, the second apparatus 202 may perform the actual scheduling and inform the first apparatus 201 of the scheduling information used in the actual scheduling.

Alternatively, in some example embodiments, the second apparatus 202 may transmit the scheduling information to the first apparatus 201 before performing actual scheduling. In such example embodiments, the scheduling information received at the first apparatus 201 is to be used for transmission of the ML-related data. The scheduling information indicates the achievable scheduling of the ML-related data.

The first apparatus 201 may receive, from the second apparatus 202, the scheduling information used for or to be used for transmission of the ML-related data. Then, the first apparatus 201 may assess (335) or evaluate the scheduling information with respect to the QoS requirement for the ML-related functionality. In other words, the first apparatus 201 may determine whether the scheduling information meets the QoS requirement for the ML-related functionality. In the case of ML-related positioning, the scheduling information may be evaluated with respect to the positioning QoS.

If the first apparatus 201 determines that the QoS requirement is not met, the procedure 380 may be performed. Specifically, the first apparatus 201 may determine (340) to update the ML-related functionality. In other words, the first apparatus 201 may adapt the ML approach for the functionality in consideration (for example, the positioning, CSI feedback, or beam management). The updated approach may require smaller amount of data or may be more robust to the ML-related data to be transferred. The update to the ML-related functionality is similar as that described above with reference to FIG. 2 and thus is not repeated here. It is to be understood that in the case that the scheduling information received from the first apparatus 201 has been used for scheduling, if the QoS requirement is not met, the ML-related functionality can also be updated, which means that the procedure 380 can be performed.

As an example without any limitation, in the case of ML-related positioning, the server UE may use or select a lower-rank positioning approach that requires smaller volume of data or that is more robust to the ML-related data provided by the UE. For example, a two-step method that uses the ML model only for an intermediate parameter of the final location estimate may be selected rather than a one-step method that depends exclusively on the ML-related data to derive the location estimate.

Next, the first apparatus 201 may transmit (345), to the second apparatus 202, an indication to update the ML-related functionality. Accordingly, the second apparatus 202 may receive the indication to update the ML-related functionality from the first apparatus 201, and then may update the ML-related functionality accordingly.

Reference is now made back to the act 335. If the first apparatus 201 determines that the QoS requirement is met, the procedure 390 may be performed. Specifically, the first apparatus 201 may transmit a confirmation of the scheduling information to the second apparatus 202. Accordingly, the second apparatus 202 may receive the confirmation from the first apparatus 201. If the scheduling information transmitted at 330 has been used for scheduling, the second apparatus 202 may continue to use the scheduling information for subsequent transmission of the ML-related data. If the scheduling transmitted at 330 is to be used for scheduling, the second apparatus 202 may schedule (355) the transmission of the ML-related data and may perform (365) data transmission accordingly via sidelink.

For example, in the environment 100C, the terminal device 120-3 may perform SL data transfer of the ML-related data according to the confirmed scheduling information. The data transmission may be performed between the terminal device 120-3 and the terminal device 113, and/or between the terminal device 120-3 and a further terminal device (not shown).

Some example embodiments are described above. The present disclosure provides a method to adapt the scheduling of data plane transmissions of UEs based on the content of the data to be used for ML-related purposes. To better understand the proposed solution for scheduling ML-related data transmission, an example process is now described. A network entity associated with a ML-related approach determines the assistance information for scheduling transmission of the ML-related data, for example, the priority for ML-related data. For example, in the ML-assisted positioning use case, the LMF determines the priority of the data to be transferred between the UE and the network for ML-assisted positioning. For simplicity, the following description is focused on the positioning case, such that the network entity of interest is the LMF, however this example can be generalized for other use cases of interest such as beam management or CSI feedback.

As part of the example process, the UEs provide to the LMF the characteristics of the ML-related data to be sent or to be received. The characteristics may include for example, the volume of data or the type of data—for the positioning use case that can be one-step or two-step positioning data, etc. Then, the LMF determines the assistance information for the ML-related data, for example, the priority for such data for the purposes of the ML-related functionality (e.g., positioning, beam management, or CSI feedback) based on the characteristics provided in previous step by the UEs.

The LMF indicates to the respective RAN node (e.g., serving gNB(s) of the respective UE) the assistance information it obtained in the previous step, for the UE of interest. For example, the data priority may be indicated to the respective RAN node, and this priority may be associated with the transfer of the data for positioning purposes, for example, for training the positioning model. The RAN node (e.g., gNB) derives the scheduling information (such as the scheduling priority) based on the data plane details of that UE (which is aware at the gNB and is independent of the positioning process) in conjunction with the ML-related data priority provided by the LMF. The RAN node may schedule UE accordingly and indicates the scheduling information to the LMF.

The LMF then evaluates the scheduling information provided by the gNB. If the scheduling information does not meet the positioning QoS requirements (known at the LMF), the LMF adapts the positioning method. As an example, the LMF may select an alternative ML-assisted positioning method which requires less volume of data, so as to accommodate the positioning method on the available scheduling priority provided by gNB. For example, the LMF may switch from a one-step method that requires large volume of data to a two-step method that requires relatively small volume of data. In another example, the LMF may decide to switch from ML-assisted positioning to non ML positioning in case the scheduling information from gNB is not sufficient to support ML-assisted positioning. The LMF uses then LPP to update the UE with the newly selected positioning method and/or positioning approach.

Example flows and process are described above. In this way, efficient mechanisms for scheduling data transfer for AI/ML can be achieved.

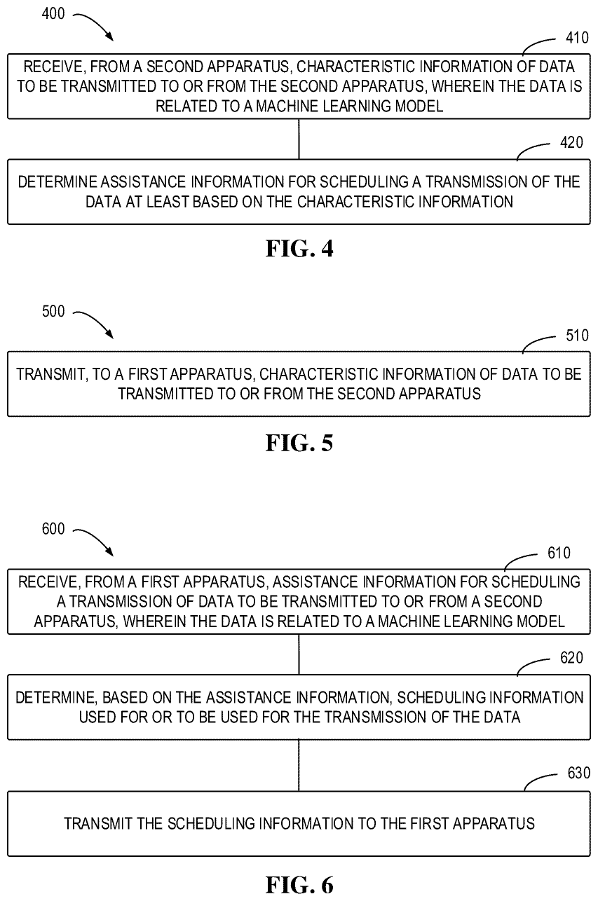

FIG. 4 shows a flowchart of an example method 400 implemented at a first apparatus in accordance with some example embodiments of the present disclosure. For the purpose of discussion, the method 400 will be described from the perspective of the first apparatus 201 in FIG. 2 or 3.

At block 410, the first apparatus receives, from a second apparatus, characteristic information of data to be transmitted to or from the second apparatus. The data is related to a machine learning model.

At block 420, the first apparatus determines assistance information for scheduling a transmission of the data at least based on the characteristic information.

In some example embodiments, the first apparatus may transmit the assistance information to a third apparatus scheduling data transmission for the first apparatus; and receive, from the third apparatus, scheduling information used for or to be used for the transmission of the data.

In some example embodiments, the method 400 further comprises: determining whether the scheduling information meets a quality of service requirement for a functionality of the machine learning model; and in accordance with a determination that the scheduling information meets the quality of service requirement, transmitting a confirmation of the scheduling information to the third apparatus.

In some example embodiments, the method 400 further comprises: in accordance with a determination that the scheduling information does not meet the quality of service requirement, determining an update to the functionality of the machine learning model based on the scheduling information; and transmitting an indication for updating the functionality of the machine learning model to at least one of the third apparatus or the second apparatus.

In some example embodiments, the first apparatus comprises a core network device or a radio access network device, the second apparatus comprises a terminal device, the third apparatus comprises a radio access network device, and the transmission of the data comprises at least one of: an uplink transmission from the terminal device to the radio access network device, or a downlink transmission from the radio access network device to the terminal device.

In some example embodiments, the first apparatus comprises a first terminal device, the second apparatus comprises a second terminal device, the third apparatus comprises a radio access network device, and the transmission of the data comprises at least one of: a sidelink transmission between the first terminal device and the second terminal device, or a sidelink transmission between the second terminal device and a third terminal device.

In some example embodiments, the first apparatus may transmit the assistance information to the second apparatus; and receive, from the second apparatus, scheduling information used for or to be used for the transmission of the data.

In some example embodiments, the method 400 further comprises: determining whether the scheduling information meets a quality of service requirement for a functionality of the machine learning model; and in accordance with a determination that the scheduling information meets the quality of service requirement, transmitting a confirmation of the scheduling information to the second apparatus.

In some example embodiments, the method 400 further comprises: in accordance with a determination that the scheduling information does not meet the quality of service requirement, determining an update to the functionality of the machine learning model based on the scheduling information; and transmitting an indication for updating the functionality of the machine learning model to the second apparatus.

In some example embodiments, the first apparatus comprises a terminal device and the second apparatus comprises another terminal device.

In some example embodiments, the method 400 further comprises: transmitting, to the second apparatus, a request for the characteristic information of the data.

In some example embodiments, the machine learning model is implemented in at least one of: the first apparatus, the second apparatus, or a third apparatus scheduling data transmission for the second apparatus.

FIG. 5 shows a flowchart of an example method 500 implemented at a second apparatus in accordance with some example embodiments of the present disclosure. For the purpose of discussion, the method 500 will be described from the perspective of the second apparatus 202 in FIG. 2 or 3.

At block 510, the second apparatus transmits, to a first apparatus, characteristic information of data to be transmitted to or from the second apparatus. The data is related to a machine learning model, and the characteristic information is used for determining assistance information for scheduling a transmission of the data.

In some example embodiments, the method 500 further comprises: receiving, from the first apparatus, an indication for updating a functionality of the machine learning model.

In some example embodiments, the method 500 further comprises: receiving, from a third apparatus, scheduling information for the transmission of the data; and performing the transmission based on the scheduling information.

In some example embodiments, the first apparatus comprises a core network device or a radio access network device, the second apparatus comprises a terminal device, the third apparatus comprises a radio access network device, and the transmission of the data comprises at least one of: an uplink transmission from the terminal device to the radio access network device, or a downlink transmission from the radio access network device to the terminal device.

In some example embodiments, the first apparatus comprises a first terminal device, the second apparatus comprises a second terminal device, the third apparatus comprises a radio access network device, and the transmission of the data comprises at least one of: a sidelink transmission between the first terminal device and the second terminal device, or a sidelink transmission between the second terminal device and a third terminal device.

In some example embodiments, the method 500 further comprises: receiving the assistance information from the first apparatus; determining, based on the assistance information, scheduling information used for or to be used for scheduling a transmission of the data; and transmitting the scheduling information to the first apparatus.

In some example embodiments, the method 500 further comprises: receiving a confirmation of the scheduling information from the first apparatus.

In some example embodiments, the first apparatus comprises a terminal device and the second apparatus comprises another terminal device.

In some example embodiments, the method 500 further comprises: receiving, from the first apparatus, a request for the characteristic information of the data.

In some example embodiments, the machine learning model is implemented in at least one of: the first apparatus, the second apparatus, or a third apparatus scheduling data transmission for the second apparatus.

FIG. 6 shows a flowchart of an example method 600 implemented at a third apparatus in accordance with some example embodiments of the present disclosure. For the purpose of discussion, the method 600 will be described from the perspective of the third apparatus 203 in FIG. 2.

At block 610, the third apparatus receives, from a first apparatus, assistance information for scheduling a transmission of data to be transmitted to or from a second apparatus. The data is related to a machine learning model.

At block 620, the third apparatus determines, based on the assistance information, scheduling information used for or to be used for the transmission of the data.

At block 630, the third apparatus transmits the scheduling information to the first apparatus.

In some example embodiments, the method 600 further comprises: receiving, from the first apparatus, a confirmation of the scheduling information.

In some example embodiments, the method 600 further comprises: receiving, from the first apparatus, an indication for updating the functionality of the machine learning model.

In some example embodiments, the first apparatus comprises a core network device or a radio access network device, the second apparatus comprises a terminal device, the third apparatus comprises a radio access network device, and the transmission of the data comprises at least one of: an uplink transmission from the terminal device to the radio access network device, or a downlink transmission from the radio access network device to the terminal device.

In some example embodiments, the first apparatus comprises a first terminal device, the second apparatus comprises a second terminal device, the third apparatus comprises a radio access network device, and the transmission of the data comprises at least one of: a sidelink transmission between the first terminal device and the second terminal device, or a sidelink transmission between the second terminal device and a third terminal device.

In some example embodiments, the machine learning model is implemented in at least one of: the first apparatus, the second apparatus, or the third apparatus.

In some example embodiments, a first apparatus capable of performing any of the method 400 (for example, the first apparatus in FIG. 2 and FIG. 3) may comprise means for performing the respective operations of the method 400. The means may be implemented in any suitable form. For example, the means may be implemented in a circuitry or software module. The first apparatus may be implemented as or included in the CN device 111, the terminal device 112 and the terminal device 113.

In some example embodiments, the first apparatus comprises means for receiving, from a second apparatus, characteristic information of data to be transmitted to or from the second apparatus, wherein the data is related to a machine learning model; and means for determining assistance information for scheduling a transmission of the data at least based on the characteristic information.

In some example embodiments, the first apparatus comprises means for transmitting the assistance information to a third apparatus scheduling data transmission for the first apparatus; and means for receiving, from the third apparatus, scheduling information used for or to be used for the transmission of the data.

In some example embodiments, the first apparatus further comprises: means for determining whether the scheduling information meets a quality of service requirement for a functionality of the machine learning model; and means for in accordance with a determination that the scheduling information meets the quality of service requirement, transmitting a confirmation of the scheduling information to the third apparatus.

In some example embodiments, the first apparatus further comprises: means for in accordance with a determination that the scheduling information does not meet the quality of service requirement, determining an update to the functionality of the machine learning model based on the scheduling information; and means for transmitting an indication for updating the functionality of the machine learning model to at least one of the third apparatus or the second apparatus.

In some example embodiments, the first apparatus comprises a core network device or a radio access network device, the second apparatus comprises a terminal device, the third apparatus comprises a radio access network device, and the transmission of the data comprises at least one of: an uplink transmission from the terminal device to the radio access network device, or a downlink transmission from the radio access network device to the terminal device.

In some example embodiments, the first apparatus comprises a first terminal device, the second apparatus comprises a second terminal device, the third apparatus comprises a radio access network device, and the transmission of the data comprises at least one of: a sidelink transmission between the first terminal device and the second terminal device, or a sidelink transmission between the second terminal device and a third terminal device.

In some example embodiments, the first apparatus comprises: means for transmitting the assistance information to the second apparatus; and means for receiving, from the second apparatus, scheduling information used for or to be used for the transmission of the data.

In some example embodiments, the first apparatus further comprises: means for determining whether the scheduling information meets a quality of service requirement for a functionality of the machine learning model; and means for in accordance with a determination that the scheduling information meets the quality of service requirement, transmitting a confirmation of the scheduling information to the second apparatus.

In some example embodiments, the first apparatus further comprises: means for in accordance with a determination that the scheduling information does not meet the quality of service requirement, determining an update to the functionality of the machine learning model based on the scheduling information; and means for transmitting an indication for updating the functionality of the machine learning model to the second apparatus.

In some example embodiments, the first apparatus comprises a terminal device and the second apparatus comprises another terminal device.

In some example embodiments, the first apparatus further comprises: means for transmitting, to the second apparatus, a request for the characteristic information of the data.

In some example embodiments, the machine learning model is implemented in at least one of: the first apparatus, the second apparatus, or a third apparatus scheduling data transmission for the second apparatus.

In some example embodiments, the first apparatus further comprises means for performing other operations in some example embodiments of the method 400 or the first apparatus 201. In some example embodiments, the means comprises at least one processor; and at least one memory storing instructions that, when executed by the at least one processor, cause the performance of the first apparatus.

In some example embodiments, a second apparatus capable of performing any of the method 500 (for example, the second apparatus in FIG. 2 and FIG. 3) may comprise means for performing the respective operations of the method 500. The means may be implemented in any suitable form. For example, the means may be implemented in a circuitry or software module. The second apparatus may be implemented as or included in the terminal device 120.

In some example embodiments, the second apparatus comprises means for transmitting, to a first apparatus, characteristic information of data to be transmitted to or from the second apparatus, wherein the data is related to a machine learning model, and wherein the characteristic information is used for determining assistance information for scheduling a transmission of the data.

In some example embodiments, the second apparatus further comprises: means for receiving, from the first apparatus, an indication for updating a functionality of the machine learning model.

In some example embodiments, the second apparatus further comprises: means for receiving, from a third apparatus, scheduling information for the transmission of the data; and means for performing the transmission based on the scheduling information.

In some example embodiments, the first apparatus comprises a core network device or a radio access network device, the second apparatus comprises a terminal device, the third apparatus comprises a radio access network device, and the transmission of the data comprises at least one of: an uplink transmission from the terminal device to the radio access network device, or a downlink transmission from the radio access network device to the terminal device.

In some example embodiments, the first apparatus comprises a first terminal device, the second apparatus comprises a second terminal device, the third apparatus comprises a radio access network device, and the transmission of the data comprises at least one of: a sidelink transmission between the first terminal device and the second terminal device, or a sidelink transmission between the second terminal device and a third terminal device.

In some example embodiments, the second apparatus further comprises: means for receiving the assistance information from the first apparatus; means for determining, based on the assistance information, scheduling information used for or to be used for scheduling a transmission of the data; and means for transmitting the scheduling information to the first apparatus.

In some example embodiments, the second apparatus further comprises: means for receiving a confirmation of the scheduling information from the first apparatus.

In some example embodiments, the first apparatus comprises a terminal device and the second apparatus comprises another terminal device.

In some example embodiments, the second apparatus further comprises: means for receiving, from the first apparatus, a request for the characteristic information of the data.

In some example embodiments, the machine learning model is implemented in at least one of: the first apparatus, the second apparatus, or a third apparatus scheduling data transmission for the second apparatus.

In some example embodiments, the second apparatus further comprises means for performing other operations in some example embodiments of the method 500 or the second apparatus 202. In some example embodiments, the means comprises at least one processor; and at least one memory storing instructions that, when executed by the at least one processor, cause the performance of the second apparatus.

In some example embodiments, a third apparatus capable of performing any of the method 600 (for example, the third apparatus 203 in FIG. 2) may comprise means for performing the respective operations of the method 600. The means may be implemented in any suitable form. For example, the means may be implemented in a circuitry or software module. The third apparatus may be implemented as or included in the RAN device 131 or 132.

In some example embodiments, the third apparatus comprises means for receiving, from a first apparatus, assistance information for scheduling a transmission of data to be transmitted to or from a second apparatus, wherein the data is related to a machine learning model; means for determining, based on the assistance information, scheduling information used for or to be used for the transmission of the data; and means for transmitting the scheduling information to the first apparatus.

In some example embodiments, the third apparatus further comprises: means for receiving, from the first apparatus, a confirmation of the scheduling information.

In some example embodiments, the third apparatus further comprises: means for receiving, from the first apparatus, an indication for updating the functionality of the machine learning model.

In some example embodiments, the first apparatus comprises a core network device or a radio access network device, the second apparatus comprises a terminal device, the third apparatus comprises a radio access network device, and the transmission of the data comprises at least one of: an uplink transmission from the terminal device to the radio access network device, or a downlink transmission from the radio access network device to the terminal device.

In some example embodiments, the first apparatus comprises a first terminal device, the second apparatus comprises a second terminal device, the third apparatus comprises a radio access network device, and the transmission of the data comprises at least one of: a sidelink transmission between the first terminal device and the second terminal device, or a sidelink transmission between the second terminal device and a third terminal device.

In some example embodiments, the machine learning model is implemented in at least one of: the first apparatus, the second apparatus, or the third apparatus.

In some example embodiments, the third apparatus further comprises means for performing other operations in some example embodiments of the method 600 or the third apparatus 203. In some example embodiments, the means comprises at least one processor;
and at least one memory storing instructions that, when executed by the at least one processor, cause the performance of the third apparatus.

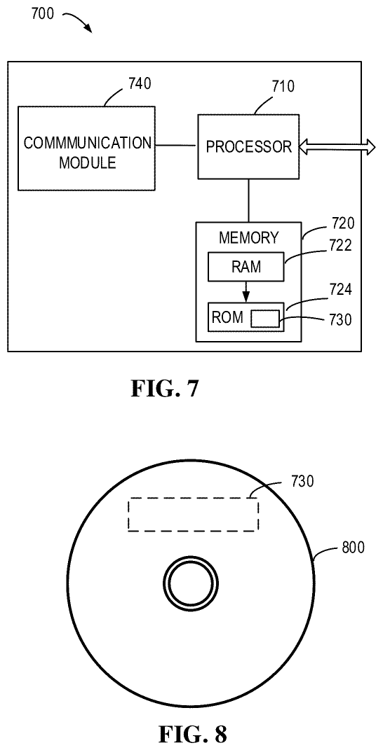

FIG. 7 is a simplified block diagram of a device 700 that is suitable for implementing example embodiments of the present disclosure. The device 700 may be provided to implement a communication device, for example, the first apparatus 201 or the second apparatus 202, or the third apparatus 203. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-34. (canceled)

35. A first apparatus comprising:
at least one processor; and
at least one memory storing instructions that, when executed by the at least one processor, cause the first apparatus at least to:
receive, from a second apparatus, characteristic information of data to be transmitted to or from the second apparatus, wherein the characteristic information of the data is related to a machine learning model, and wherein the characteristic information of the data further comprises the following: statistic information, location information, timestamps, measurements for obtaining the data, and configurations associated with the characteristic information of the data, wherein the configurations comprise reception point anchors, positioning reference signal resource, bandwidth, and comb-size; and
determine assistance information for scheduling a transmission of the data at least based on the characteristic information of the data, wherein the assistance information comprises: a priority of the data and scheduling requirements for transferring the data, the scheduling requirements comprising: quality of service boundaries, maximum range of throughput, minimum range of throughput, data volume, payload, latency, and modulation and coding schemes;
transmit the assistance information to a third apparatus;
receive, from the third apparatus, scheduling information that is based on the assistance information and a user plane condition of the second apparatus, the scheduling information comprising: a scheduling priority of the transmission of the data, parameters related to quality of service achievable to transfer the data, the parameters comprising: the quality of service boundaries, the maximum range of throughput, the minimum range of throughput, the data volume, the payload, the latency, and the modulation and coding schemes;
determine that the scheduling information does not meet a quality of service requirement for a functionality of the machine learning model;
in accordance with the determination that the scheduling information does not meet the quality of service requirement, determine an update to the functionality of the machine learning model based on the scheduling information; and
transmit an indication for updating the functionality of the machine learning model to the third apparatus and the second apparatus.

36. The first apparatus of claim 35, wherein the first apparatus comprises a core network device or a radio access network device, the second apparatus comprises a terminal device, and the third apparatus comprises a radio access network device.

37. The first apparatus of claim 36, wherein the transmission of the data comprises an uplink transmission from the terminal device to the radio access network device.

38. The first apparatus of claim 37, wherein the transmission of the data further comprises a downlink transmission from the radio access network device to the terminal device.

39. The first apparatus of claim 35, wherein the first apparatus comprises a first terminal device, the second apparatus comprises a second terminal device, the third apparatus comprises a radio access network device.

40. The first apparatus of claim 39, wherein the transmission of the data comprises a sidelink transmission between the first terminal device and the second terminal device.

41. The first apparatus of claim 40, wherein the transmission of the data comprises a sidelink transmission between the second terminal device and a third terminal device.

42. The first apparatus of claim 35, wherein the first apparatus comprises a terminal device and the second apparatus comprises another terminal device.

43. A system comprising:
a first apparatus:
at least one processor; and
at least one memory storing instructions that, when executed by the at least one processor, cause the first apparatus at least to:
receive, from a second apparatus, characteristic information of data to be transmitted to or from the second apparatus, wherein the characteristic information of the data is related to a machine learning model, and wherein the characteristic information of the data further comprises the following: statistic information, location information, timestamps, measurements for obtaining the data, and configurations associated with the characteristic information of the data, wherein the configurations comprise reception point anchors, positioning reference signal resource, bandwidth, and comb-size; and
determine assistance information for scheduling a transmission of the data at least based on the characteristic information of the data, wherein the assistance information comprises: a priority of the data and scheduling requirements for transferring the data, the scheduling requirements comprising: quality of service boundaries, maximum range of throughput, minimum range of throughput, data volume, payload, latency, and modulation and coding schemes;
transmit the assistance information to a third apparatus;
receive, from the third apparatus, scheduling information that is based on the assistance information and a user plane condition of the second apparatus, the scheduling information comprising: a scheduling priority of the transmission of the data, parameters related to quality of service achievable to transfer the data, the parameters comprising: the quality of service boundaries, the maximum range of throughput, the minimum range of throughput, the data volume, the payload, the latency, and the modulation and coding schemes;
determine that the scheduling information does not meet a quality of service requirement for a functionality of the machine learning model;
in accordance with the determination that the scheduling information does not meet the quality of service requirement, determine an update to the functionality of the machine learning model based on the scheduling information; and
transmit an indication for updating the functionality of the machine learning model to the third apparatus and the second apparatus.

44. The system of claim 43, wherein the first apparatus comprises a core network device or a radio access network device, the second apparatus comprises a terminal device, and the third apparatus comprises a radio access network device.

45. The system of claim 44, wherein the transmission of the data comprises an uplink transmission from the terminal device to the radio access network device.

46. The system of claim 45, wherein the transmission of the data further comprises a downlink transmission from the radio access network device to the terminal device.

47. The system of claim 43, wherein the first apparatus comprises a first terminal device, the second apparatus comprises a second terminal device, the third apparatus comprises a radio access network device.

48. The system of claim 47, wherein the transmission of the data comprises a sidelink transmission between the first terminal device and the second terminal device.

49. The system of claim 48, wherein the transmission of the data comprises a sidelink transmission between the second terminal device and a third terminal device.

50. The system of claim 43, wherein the first apparatus comprises a terminal device and the second apparatus comprises another terminal device.

51. A method comprising:
receiving, from a second apparatus, characteristic information of data to be transmitted to or from the second apparatus, wherein the characteristic information of the data is related to a machine learning model, and wherein the characteristic information of the data further comprises the following: statistic information, location information, timestamps, measurements for obtaining the data, and configurations associated with the characteristic information of the data, wherein the configurations comprise reception point anchors, positioning reference signal resource, bandwidth, and comb-size; and
determining assistance information for scheduling a transmission of the data at least based on the characteristic information of the data, wherein the assistance information comprises: a priority of the data and scheduling requirements for transferring the data, the scheduling requirements comprising: quality of service boundaries, maximum range of throughput, minimum range of throughput, data volume, payload, latency, and modulation and coding schemes;
transmitting the assistance information to a third apparatus;
receiving, from the third apparatus, scheduling information that is based on the assistance information and a user plane condition of the second apparatus, the scheduling information comprising: a scheduling priority of the transmission of the data, parameters related to quality of service achievable to transfer the data, the parameters comprising: the quality of service boundaries, the maximum range of throughput, the minimum range of throughput, the data volume, the payload, the latency, and the modulation and coding schemes;
determining that the scheduling information does not meet a quality of service requirement for a functionality of the machine learning model;
in accordance with the determination that the scheduling information does not meet the quality of service requirement, determining an update to the functionality of the machine learning model based on the scheduling information; and
transmitting an indication for updating the functionality of the machine learning model to the third apparatus and the second apparatus.

52. The method of claim 51, wherein the first apparatus comprises a core network device or a radio access network device, the second apparatus comprises a terminal device, and the third apparatus comprises a radio access network device, and wherein the transmission of the data comprises an uplink transmission from the terminal device to the radio access network device, and a downlink transmission from the radio access network device to the terminal device.

53. The method of claim 51, wherein the first apparatus comprises a first terminal device, the second apparatus comprises a second terminal device, the third apparatus comprises a radio access network device, and wherein the transmission of the data comprises a sidelink transmission between the first terminal device and the second terminal device, and a sidelink transmission between the second terminal device and a third terminal device.

54. The method of claim 51, wherein the first apparatus comprises a terminal device and the second apparatus comprises another terminal device.
